(19) United States
(12) Patent Application Publication
(10) Pub. No.: US 2022/0114769 A1
(43) Pub. Date: Apr. 14, 2022

(54) Imaging Apparatus and Imaging Method

(71) Applicant: SHIMADZU CORPORATION, Kyoto (JP)

(72) Inventors: Takashi OMORI, Kyoto-shi (JP); Atsushi KASATANI, Kyoto-shi (JP)

(21) Appl. No.: 17/496,526

(22) Filed: Oct. 7, 2021

(30) Foreign Application Priority Data
Oct. 8, 2020 (JP) 2020-170278
Sep. 28, 2021 (JP) 2021-158179

(51) Int. Cl. G06T 11/00; G06T 7/70

(52) U.S. Cl. CPC G06T 11/00; G06T 7/70; G06T 2207/30196; G06T 2207/10152; G06T 2200/04

(57) ABSTRACT

An imaging apparatus includes a body contour imager that obtains a body contour image that shows a body contour of a target portion of a subject by detecting terahertz light radiated from the target portion of the subject with his/her apparel on, an outside shape imager that obtains an outside shape image that shows an outside shape of the apparel in the target portion, combination means that generates a combined image by combining the body contour image and the outside shape image with each other, and output means that provides output of the combined image generated by the combination means.

### BACKGROUND OF THE INVENTION

### Field of the Invention

The present invention relates to an imaging apparatus and an imaging method.

### Description of the Background Art

Japanese Patent Laying-Open No. 2005-169015 discloses an advising system for fitting ready-made shoes, which is adjusted to advise a user of ready-made shoes that will fit to a foot shape of the user. The system includes a three-dimensional foot shape dimension measurement apparatus and a fitting ready-made shoe advising apparatus. The three-dimensional foot shape dimension measurement apparatus contains a large number of CCD cameras and it is configured to measure a dimension of each part of the user's foot by imaging the user's foot placed in a recess. The fitting ready-made shoe advising apparatus selects data on a shoe shape that will fit the foot shape of the user based on three-dimensional foot dimension data which is data on a dimension of each part of the user's foot.

### SUMMARY OF THE INVENTION

In Japanese Patent Laying-Open No. 2005-169015, the system is configured to select data on the shoe shape that will best fit based on the three-dimensional foot shape dimension data of the user without the user's shoes on. Therefore, the system is unable to accurately detect a shape and a position of the foot in the inside of the shoe and a clearance between the shoe and the foot while the user is wearing the shoe. This means that how well the selected shoe fits the foot shape of the user and comfortableness of the shoe cannot objectively be evaluated but they are evaluated only based on the user's subjective feeling. In particular, when the user is a small child, the user's subjective feeling means to be easily ambiguous. Therefore, users may have difficulty in choosing their shoes.

The present invention was made to solve such a problem, and an object thereof is to provide an imaging apparatus and an imaging method that allow visual detection of a state of a body with respect to apparel with the subject's apparel on.

An imaging apparatus according to one aspect of the present invention includes a body contour imager that obtains a body contour image that shows a body contour of a target portion of a subject, by detecting terahertz light radiated from the target portion of the subject with the subject's apparel on, an outside shape imager that obtains an outside shape image that shows an outside shape of the apparel in the target portion, combination means that generates a combined image by combining the body contour image and the outside shape image with each other, and output means that provides output of the combined image generated by the combination means.

An imaging apparatus according to another aspect of the present invention includes a light source that generates terahertz light, a body contour imager that obtains a body contour image that shows a body contour of a target portion of a subject, by irradiating the target portion of the subject with the subject's apparel on with the terahertz light from the light source, an outside shape imager that obtains an outside shape image that shows an outside shape of the apparel in the target portion, and output means that provides output of a combined image obtained by combining the body contour image and the outside shape image with each other.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a schematic configuration of an imaging apparatus according to a first embodiment.

FIG. 2 is a block diagram showing an exemplary functional configuration of a controller shown in FIG. 1.

FIG. 3 is a diagram showing an exemplary image obtained by an image processing unit.

FIG. 4 is a flowchart for illustrating a processing procedure in the imaging apparatus according to the first embodiment.

FIG. 5 is a diagram showing a schematic configuration of an imaging apparatus according to a second embodiment.

FIG. 6 is a diagram showing an exemplary configuration of a light source.

FIG. 7 is a diagram showing an exemplary transmission spectrum of terahertz light.

FIG. 8 is a diagram showing an exemplary image obtained by imaging by a detector.

FIG. 9 is a block diagram showing an exemplary functional configuration of a controller shown in FIG. 5.

FIG. 10 is a flowchart for illustrating a processing procedure in the imaging apparatus according to the second embodiment.

FIG. 11 is a diagram showing a schematic configuration of an imaging apparatus according to a third embodiment.

FIG. 12 is a diagram showing an exemplary configuration of a light source and a first detector.

FIG. 13 is a diagram schematically showing a time waveform of intensity of reflected light detected by a terahertz light detector.

FIG. 14 is a block diagram showing an exemplary functional configuration of a controller shown in FIG. 11.

FIG. 15 is a flowchart for illustrating a processing procedure in the imaging apparatus according to the third embodiment.

FIG. 16 is a diagram showing a schematic configuration of an imaging apparatus according to a fourth embodiment.

FIG. 17 is a diagram showing an exemplary configuration of a first detector.

FIG. 18 is a diagram showing measurement principles of the first detector.

FIG. 19 is a block diagram showing an exemplary functional configuration of a controller shown in FIG. 16.

### DESCRIPTION OF THE PREFERRED EMBODIMENTS

An embodiment of the present invention will be described below in detail with reference to the drawings. The same or corresponding elements in the drawings have the same reference characters allotted and description thereof will not be repeated in principle.

### First Embodiment

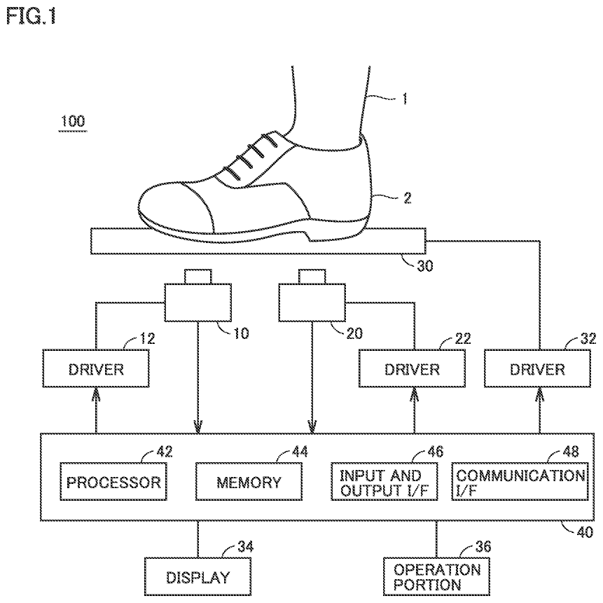

FIG. 1 is a diagram showing a schematic configuration of an imaging apparatus 100 according to a first embodiment. Imaging apparatus 100 according to the first embodiment is configured to image a target portion of a subject with his/her apparel on. “Apparel” herein is a collective denotation of covering that covers and wraps each part of a human body for a wearing purpose and encompasses clothing, shoes, and headwear. In an example in FIG. 1, imaging apparatus 100 according to the first embodiment is configured to image a foot 1 of a subject with his/her shoe 2 on. In other words, in the exemplary configuration in FIG. 1, shoe 2 is defined as the apparel and foot 1 of the subject is defined as the target portion. The target portion includes at least the toe and the heel of foot 1.

As shown in FIG. 1, imaging apparatus 100 includes a first detector 10, a second detector 20, a stage 30, drivers 12, 22, and 32, a controller 40, a display 34, and an operation portion 36.

Foot 1 of the subject with his/her shoe 2 on is placed on stage 30. For example, stage 30 is constructed such that the subject with his/her shoe 2 on can stand thereon.

Driver 32 drives stage 30. Specifically, driver 32 includes a movement mechanism (not shown) that moves stage 30 in at least one of a horizontal direction and a vertical direction. The horizontal direction corresponds to a left-right direction along the sheet plane and a direction perpendicular to the sheet plane in FIG. 1, and the vertical direction corresponds to an up-down direction along the sheet plane. Driver 32 further includes a turning mechanism (not shown) that turns stage 30 around the vertical direction.

First detector 10 is a passive camera that detects terahertz light radiated from an object to image the object. First detector 10 is arranged to include at least shoe 2 within an imaging range. Terahertz light radiated from foot 1 of a subject passes through shoe 2 formed of fabric or leather. First detector 10 obtains a foot shape image that shows a shape of foot 1 (which is also referred to as a “foot shape” below) covered with shoe 2 by detecting terahertz light that has passed through shoe 2. First detector 10 provides output of the obtained foot shape image to controller 40. The foot shape image corresponds to one embodiment of the “body contour image.”

In general, “terahertz light” refers to electromagnetic waves belonging to a frequency range (specifically, 0.1 THz to 10 THz) around 1 THz (=10¹² Hz) and herein refers to electromagnetic waves from 0.1 THz to 1 THz. Terahertz light is characterized in both of linearity of light and penetrability of electromagnetic waves. In the first embodiment, a frequency of terahertz light detected by first detector 10 can be selected depending on a shape and a material of shoe 2.

First detector 10 includes a terahertz light detector. In one example, the terahertz light detector includes an antenna that receives terahertz light and a mixer that extracts a desired component from received terahertz light by mixing. The mixer may include a diode made of a semiconductor that allows a high speed operation, such as low-temperature grown gallium arsenide (LT-GaAs). Terahertz light can be detected by heterodyne detection by the diode. Alternatively, first detector 10 may include as a terahertz light detection element, a Schottkey barrier diode, a pyroelectric detector, a bolometer, a Golay cell, a complementary metal oxide semiconductor (CMOS) antenna, or a resonant tunnel diode (RTD). A known terahertz light camera can be applied as first detector 10. In another example, an optical system such as a condenser lens for receiving terahertz light may be employed for first detector 10.

Driver 12 drives first detector 10. Driver 12 includes a movement mechanism (not shown) that moves first detector 10. The foot shape image showing a three-dimensional shape of foot 1 can be obtained based on images from a plurality of points of view resulting from imaging while first detector 10 is moved as being driven by the movement mechanism. A known structure-from-motion (SfM) technique can be used for generation of a three-dimensional foot shape image.

Alternatively, first detector 10 can be composed of a plurality of terahertz light cameras. The plurality of terahertz light cameras are arranged as high as shoe 2 and in parallel to shoe 2. The foot shape image showing the three-dimensional shape of foot 1 can be obtained from a parallax between images resulting from imaging by the terahertz light cameras, based on the principles of triangulation.

In addition to or instead of movement of first detector 10 by driver 12, movement of stage 30 by driver 32 may be used for generation of the three-dimensional foot shape image.

Second detector 20 is arranged to include at least shoe 2 within a range of image pick-up. Second detector 20 obtains an outside shape image showing an outside shape of shoe 2 by detecting electromagnetic waves different in frequency from terahertz light. Visible light or infrared waves can be employed as electromagnetic waves different in frequency. Second detector 20 provides output of the obtained outside shape image to controller 40. The outside shape image of shoe 2 corresponds to one embodiment of the “outside shape image.”

Second detector 20 is implemented, for example, by a visible light camera. The visible light camera includes an optical system such as a lens and an image pick-up element such as a charge coupled device (CCD) sensor or a complementary metal oxide semiconductor (CMOS) sensor. The visible light camera obtains the outside shape image by converting visible light incident through the optical system into an electrical signal.

Driver 22 drives second detector 20. Driver 22 includes a movement mechanism (not shown) that moves second detector 20. The outside shape image showing a three-dimensional shape of shoe 2 can be obtained based on images from a plurality of points of view resulting from imaging while second detector 20 is moved as being driven by the movement mechanism. A known SfM technique can be used for generation of a three-dimensional outside shape image.

Alternatively, second detector 20 can be composed of a plurality of visible light cameras. The plurality of visible light cameras are arranged as high as shoe 2 and in parallel to shoe 2. The outside shape image showing the three-dimensional shape of shoe 2 can be obtained from a parallax between images resulting from imaging by the visible light cameras, based on the principles of triangulation.

In addition to or instead of movement of second detector 20 by driver 22, movement of stage 30 by driver 32 may be used for generation of the three-dimensional outside shape image.

Laser radar can be applied as second detector 20 instead of the visible light camera. The laser radar determines a distance from a position thereof to a position of shoe 2 by emitting laser beams toward shoe 2 and measuring a time of flight (TOF) until laser beams are reflected back by shoe 2. The laser radar can obtain the outside shape image showing the three-dimensional shape of shoe 2 by performing such processing while it scans a surface of shoe 2 with laser beams. In this case, driver 22 implements laser beam scanning means that varies a direction of irradiation with laser beams.

Controller 40 controls the entire imaging apparatus 100. Controller 40 includes, as its main components, a processor 42, a memory 44, an input and output interface (I/F) 46, and a communication I/F 48. These components are communicatively connected to one another through a not-shown bus.

Processor 42 is typically a computing processing unit such as a central processing unit (CPU) or a micro processing unit (MPU). Processor 42 controls operations of each component of imaging apparatus 100 by reading and executing a program stored in memory 44. Specifically, processor 42 performs processing of imaging apparatus 100 which will be described later by executing the program. Though the example in FIG. 1 illustrates a configuration in which a single processor is provided, controller 40 may be configured to include a plurality of processors.

Memory 44 is implemented by a non-volatile memory such as a random access memory (RAM), a read only memory (ROM), and a flash memory. A program executed by processor 42 or data used by processor 42 is stored in memory 44.

Input and output I/F 46 is an interface for exchanging various types of data between processor 42 and components such as detectors 10 and 20 and drivers 12, 22, and 32.

Communication I/F 48 is an interface for exchanging various types of data between imaging apparatus 100 and an external apparatus and implemented by an adapter or a connector. Communication may be wireless communication such as wireless local area network (LAN) or wired communication through a universal serial bus (USB).

Display 34 and operation portion 36 are connected to controller 40. Display 34 is implemented by a liquid crystal panel. Operation portion 36 accepts an operation input from a user onto imaging apparatus 100. Operation portion 36 is typically constituted of a touch panel, a keyboard, and/or a mouse.

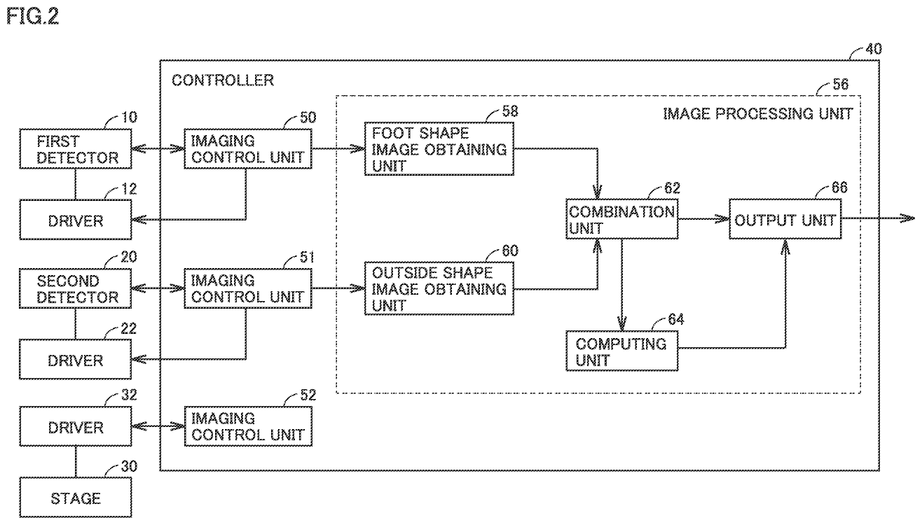

FIG. 2 is a block diagram showing an exemplary functional configuration of controller 40 shown in FIG. 1. As shown in FIG. 2, controller 40 includes imaging control units 50, 51, and 52 and an image processing unit 56.

Each function of controller 40 is performed, for example, by reference by processor 42 to a control program or various types of data stored in memory 44. A part or the entirety of the functions may be performed by processing by a digital signal processor (DSP) instead of or together with processing by processor 42. Similarly, a part or the entirety of the functions may be performed by processing by dedicated hardware circuitry (for example, an application specific integrated circuit (ASIC) or a field programmable gate array (FPGA)) instead of or together with processing by software.

Imaging control unit 50 controls operations of first detector 10 and driver 12. Specifically, imaging control unit 50 provides an imaging instruction to first detector 10. During imaging by first detector 10, imaging control unit 50 activates driver 12 to move first detector 10. A two-dimensional foot shape image for each point of view when foot 1 is viewed from various points of view can thus be obtained.

Imaging control unit 51 controls operations of second detector 20 and driver 22. Specifically, imaging control unit 51 provides an imaging instruction to second detector 20. During imaging by second detector 20, imaging control unit 51 activates driver 22 to move second detector 20. A two-dimensional outside shape image for each point of view when shoe 2 is viewed from various points of view can thus be obtained.

Imaging control unit 52 controls operations of driver 32. Specifically, when stage 30 is moved in addition to movement of first detector 10 and second detector 20, imaging control unit 52 controls driver 32 to operate in synchronization with operations of drivers 12 and 22. Alternatively, when stage 30 is moved instead of movement of first detector 10 and second detector 20, imaging control unit 52 controls driver 32 to operate in synchronization with imaging by detectors 10 and 20.

Image processing unit 56 includes a foot shape image obtaining unit 58, an outside shape image obtaining unit 60, a combination unit 62, a computing unit 64, and an output unit 66.

Foot shape image obtaining unit 58 obtains from imaging control unit 50, a foot shape image (two-dimensional image) resulting from imaging by first detector 10. Foot shape image obtaining unit 58 generates a three-dimensional foot shape image based on foot shape images from a plurality of points of view resulting from imaging by first detector 10. A known image processing technique can be adopted for generation of the three-dimensional foot shape image. First detector 10 and foot shape image obtaining unit 58 correspond to one embodiment of the “body contour imager.”

Outside shape image obtaining unit 60 obtains from imaging control unit 51, an outside shape image (two-dimensional image) resulting from imaging by second detector 20. Outside shape image obtaining unit 60 generates a three-dimensional outside shape image based on outside shape images from a plurality of points of view resulting from imaging by second detector 20. A known image processing technique can be adopted for generation of a three-dimensional outside shape image. Second detector 20 and outside shape image obtaining unit 60 correspond to one embodiment of the “outside shape imager.”

Combination unit 62 generates a combined image by combining the foot shape image obtained by foot shape image obtaining unit 58 and the outside shape image obtained by outside shape image obtaining unit 60 with each other. Combination unit 62 corresponds to one embodiment of the “combination means.”

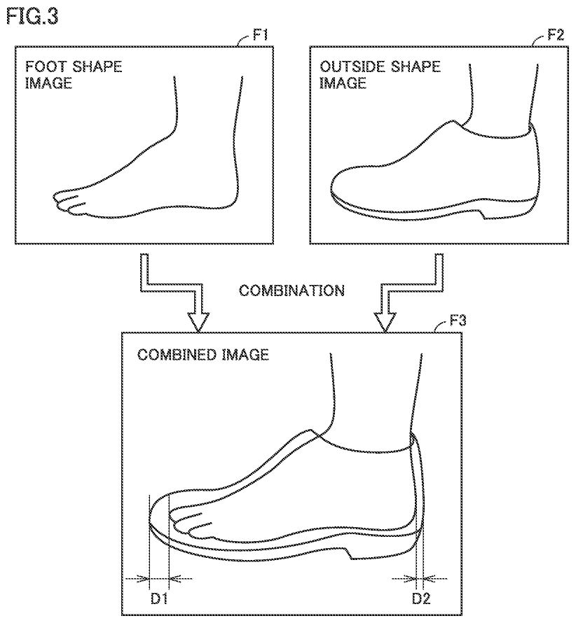

FIG. 3 is a diagram showing an exemplary image obtained by image processing unit 56. FIG. 3 shows a foot shape image F1 obtained by foot shape image obtaining unit 58, an outside shape image F2 obtained by outside shape image obtaining unit 60, and a combined image F3 generated by combination unit 62.

Foot shape image F1 includes a contour line that represents a shape of foot 1 of a subject. Outside shape image F2 includes a contour line that represents a shape of shoe 2. Combined image F3 is an image resulting from combination of foot shape image F1 and outside shape image F2 with each other. Therefore, the contour line of foot 1 and the contour line of shoe 2 are shown as being superimposed on each other in combined image F3. In combined image F3, a state of foot 1 with respect to shoe 2 (a shape and a position of the toe and the heel in the inside of shoe 2) can visually be detected.

As shown in combined image F3, a clearance is provided in at least a portion between an inner side of shoe 2 and a surface of foot 1. This clearance may mainly be provided around a portion of foot 1 such as the toe, the heel, the instep, and the arch. In general, from a point of view of lightening of load applied to the foot and prevention of lowering in motion function, a proper value is set for a size of the clearance in each portion. For example, the proper value of the size of the clearance provided around the toe is set to approximately 1 to 1.5 cm. The heel is desirably securely covered with the shoe and there is no clearance therearound. The instep and the arch are desirably moderately fitted to the inner side of the shoe and not compressed by the shoe. Therefore, in a scene of purchase of shoes, a user can choose suitable shoes that conform to his/her foot shape by checking a position of each portion of the foot with the shoe on, presence of the clearance provided around each portion of the foot, and the size of the clearance.

Conventionally, however, a user or a salesperson generally checks a position of each portion of the foot in the inside of the shoe by touching the foot over the outer surface of the shoe, and it has been difficult to accurately detect presence of the clearance in the inside of the shoe and the size thereof. Therefore, whether or not the shoe fits the foot shape of the user and comfortableness (fitting) of the shoe cannot objectively be evaluated but they are evaluated only based on the user's subjective feeling. In particular, when the user is a small child, the user's subjective feeling is also ambiguous. Therefore, extreme difficulty in choice of shoes is a concern.

Imaging apparatus 100 according to the first embodiment allows visual detection of a state of foot 1 with respect to shoe 2 (the shape and the position of foot 1 and the clearance in the inside of shoe 2) by obtaining foot shape image F1 of the user and outside shape image F2 and generating combined image F3 thereof.

Referring back to FIG. 2, combination unit 62 provides output of the combined image to output unit 66 and computing unit 64. Output unit 66 has the combined image shown on display 34 (see FIG. 1). Output unit 66 further transmits image data of the combined image to an external apparatus through communication I/F 48 (see FIG. 1).

Computing unit 64 measures the size of the clearance provided between the inner side of shoe 2 and the surface of foot 1 based on the combined image. In an example in FIG. 3, a size D1 of the clearance provided around the toe of foot 1 and a size D2 of the clearance provided around the heel are measured. A known image analysis technique can be used for measurement. Though not shown, computing unit 64 can measure the size of the clearance provided around the arch and the instep of foot 1 based on a combined image from another point of view.

Computing unit 64 provides a measurement value of the size of the clearance to output unit 66. Output unit 66 has the measurement value shown on display 34 and transmits data on the measurement value to the external apparatus through communication I/F 48.

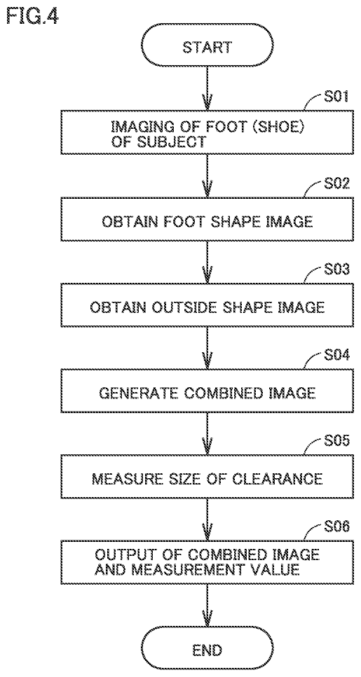

FIG. 4 is a flowchart for illustrating a processing procedure in imaging apparatus 100 according to the first embodiment.

As shown in FIG. 4, in step S01, imaging apparatus 100 images foot 1 of a subject with his/her shoe 2 on by means of first detector 10 and second detector 20. In step S01, first detector 10 obtains a foot shape image showing a shape of foot 1 covered with shoe 2 by detecting terahertz light radiated from foot 1 of the subject through shoe 2. Imaging apparatus 100 obtains foot shape images from a plurality of points of view by moving first detector 10 with driver 12 and/or moving stage 30 with driver 32. Second detector 20 obtains the outside shape image showing the outside shape of shoe 2 by detecting electromagnetic waves (for example, visible light or infrared waves) different in wavelength from terahertz light. Imaging apparatus 100 obtains outside shape images from a plurality of points of view by moving second detector 20 with driver 22 and/or moving stage 30 with driver 32.

In step S02, controller 40 of imaging apparatus 100 obtains the foot shape image resulting from imaging by first detector 10. Controller 40 generates a three-dimensional foot shape image based on foot shape images from a plurality of points of view resulting from imaging by first detector 10.

In step S03, controller 40 obtains the outside shape image resulting from imaging by second detector 20. Controller 40 generates a three-dimensional outside shape image based on outside shape images from a plurality of points of view resulting from imaging by second detector 20.

In step S04, controller 40 generates a combined image by combining the foot shape image obtained in step S02 and the outside shape image obtained in step S03 with each other.

In step S05, controller 40 measures the size of the clearance provided between the inner side of shoe 2 and the surface of foot 1 based on the combined image generated in step S04. In step S05, controller 40 measures the size of the clearance provided in each portion including at least a toe portion and a heel portion of foot 1.

In step S06, controller 40 provides output of the combined image and a measurement value of the size of the clearance. Controller 40 has the combined image and the measurement value shown on display 34 (see FIG. 1) and transmits the combined image and data on the measurement value to an external apparatus through communication I/F 48.

As described above, imaging apparatus 100 according to the first embodiment can visually detect the state (the shape and the position of the foot and the clearance in the inside of the shoe) of the foot with respect to the shoe by detecting terahertz light radiated from the foot of the subject with his/her shoe on to obtain the foot shape image and the outside shape image of the shoe and generating the combined image of the foot shape image and the outside shape image. Thus, whether or not a shoe fits to the foot shape of a user and comfortableness of the shoe can objectively be evaluated without relying on the user's subjective feeling.

### Second Embodiment

In the first embodiment above, a configuration in which a passive imaging technique to image a shape of a foot in the inside of a shoe by detecting terahertz light radiated from the foot is used for a foot shape imager that obtains a foot shape image is described. In second to fourth embodiments, a configuration in which an active imaging technique to image a shape of a foot in the inside of a shoe by irradiating the shoe with terahertz light at an already-known frequency and detecting transmitted light or reflected light thereof will be described. Initially, in the second embodiment, an exemplary configuration in which the active imaging technique using transmitted light from a shoe will be described.

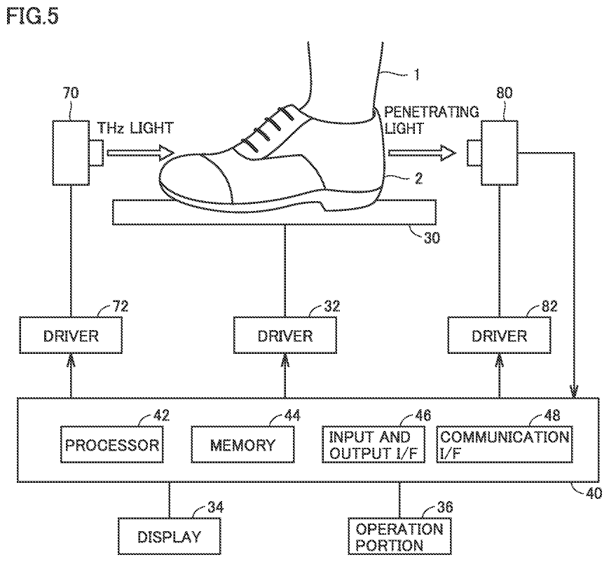

FIG. 5 is a diagram showing a schematic configuration of imaging apparatus 100 according to the second embodiment. As shown in FIG. 5, imaging apparatus 100 according to the second embodiment includes stage 30, a light source 70, a detector 80, drivers 32, 72, and 82, controller 40, display 34, and operation portion 36. Imaging apparatus 100 according to the second embodiment is different from imaging apparatus 100 according to the first embodiment in including light source 70, detector 80, and drivers 72 and 82 instead of detectors 10 and 20 and drivers 12 and 22. Since the second embodiment is otherwise identical in configuration to the first embodiment, description will not be repeated.

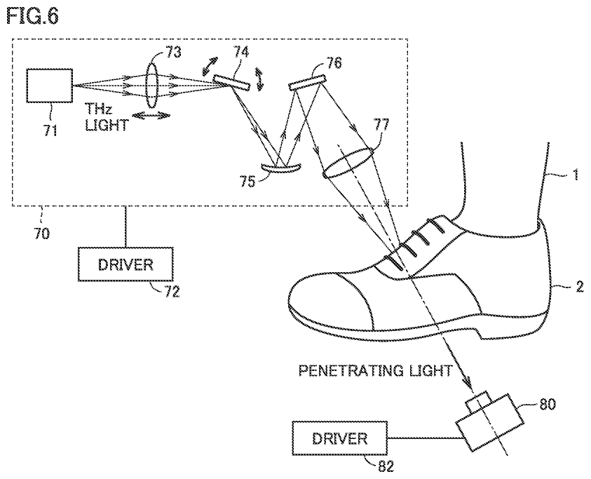

Light source 70 generates terahertz light. Light source 70 is arranged to include at least shoe 2 within a range of irradiation with terahertz light. FIG. 6 is a diagram showing an exemplary configuration of light source 70. As shown in FIG. 6, light source 70 includes a terahertz light generator 71, condenser lenses 73 and 77, and reflection mirrors 74, 75, and 76. Driver 72 is configured to drive and move light source 70.

In one example, terahertz light generator 71 includes a microwave generator and a frequency multiplier that generates a signal at a target frequency from generated microwaves. In another example, terahertz wave generator 71 includes a terahertz light generation element. A laser light source and a photoconductive antenna (PCA), a photomixer, or a semiconductor oscillator can be employed as a terahertz light generation element. Condenser lenses 73 and 77 and reflection mirrors 74, 75, and 76 compose an optical system that guides terahertz light emitted from terahertz light generator 71 to the surface of shoe 2. The surface of shoe 2 is irradiated with terahertz light condensed like spotlight by the optical system. Terahertz light may be continuous waves at a single frequency or pulsed light. In the second embodiment, a frequency of terahertz light generated by light source 70 can be selected depending on a shape and a material of shoe 2.

Condenser lens 73 is constructed as being movable in a direction of travel of terahertz light. Reflection mirror 74 is constructed to change an incident angle of terahertz light. Driver 72 includes a movement mechanism (not shown) that moves condenser lens 73 and reflection mirror 74. By driving the movement mechanism, the surface of shoe 2 can be scanned with terahertz light emitted like spotlight. In addition to or instead of drive of light source 70 by driver 72, movement of stage 30 by driver 32 may be used for scanning with terahertz light. Driver 72 and/or driver 73 correspond(s) to one embodiment of “scanning means.”

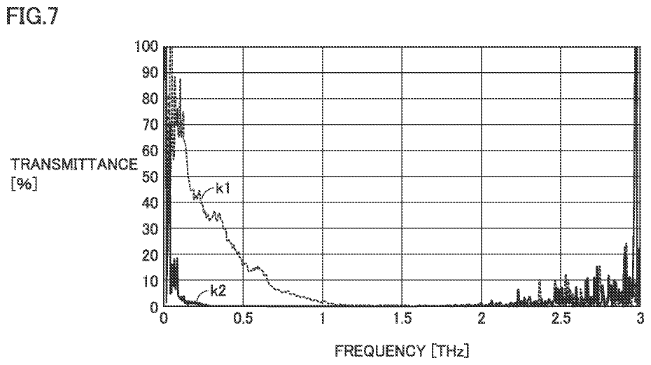

Some of terahertz light emitted from light source 70 to shoe 2 is absorbed by foot 1 and remainder passes through shoe 2. FIG. 7 is a diagram showing an exemplary transmission spectrum of terahertz light. In FIG. 7, a waveform k1 represents a transmission spectrum only of shoe 2 and a waveform k2 shows a transmission spectrum of foot 1 with shoe 2 being put thereon. The transmission spectrum in FIG. 7 represents transmittance at each frequency when a frequency of terahertz light emitted from light source 70 is varied within a range from 0 to 3 THz.

In the example in FIG. 7, there is a difference between two transmittances in the frequency range not higher than 1 THz. In this frequency range, the transmittance only through shoe 2 lowers with increase in frequency, whereas the transmittance through foot 1 is fixed to approximately 0% regardless of the frequency. Therefore, an image of foot 1 in the inside of shoe 2 that cannot be observed with visible light can be obtained by irradiation of shoe 2 with terahertz light in this frequency range.

Referring back to FIG. 6, detector 80 detects terahertz light that has passed through shoe 2. Specifically, in one example, detector 80 includes an antenna that receives terahertz light and a mixer that extracts a desired component from received terahertz light by mixing. Alternatively, a Schottkey barrier diode, a pyroelectric detector, a bolometer, a Golay cell, a CMOS antenna, or a resonant tunnel diode can be employed as a terahertz light detection element. In another example, an optical system such as a condenser lens for receiving terahertz light may be employed for detector 80.

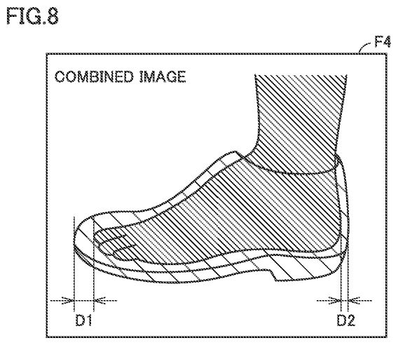

Driver 82 drives detector 80. Driver 82 includes a movement mechanism (not shown) that moves detector 80. Imaging apparatus 100 can obtain an image based on detected transmitted light by driving the movement mechanism to move detector 80 in synchronization with scanning with terahertz light from light source 70. In addition to or instead of drive of light source 70 by driver 72 and movement of detector 80 by driver 82, movement of stage 30 by driver 32 may be used for generation of an image. FIG. 8 is a diagram showing an exemplary image obtained by imaging by detector 80. As shown in FIG. 8, an image F4 obtained by detector 80 is an image with contrast in accordance with a difference in transmittance shown in FIG. 7. For example, when shoe 2 is irradiated with terahertz light having a frequency of 0.6 THz, the transmittance (first transmittance) of foot 1 with shoe 2 being put thereon is approximately 0% and the transmittance (second transmittance) only of shoe 2 is approximately 15%. According to this result, in image F4, a foot shape image obtained based on transmitted light that has passed through shoe 2 and foot 1 at first transmittance (0%) and an outside shape image obtained based on transmitted light that has passed only through shoe 2 at second transmittance (15%) are formed. In other words, image F4 is a combined image resulting from combination of the foot shape image and the outside shape image with each other. Therefore, with image F4, the shape and the position of foot 1 and the clearance in the inside of shoe 2 can visually be detected.

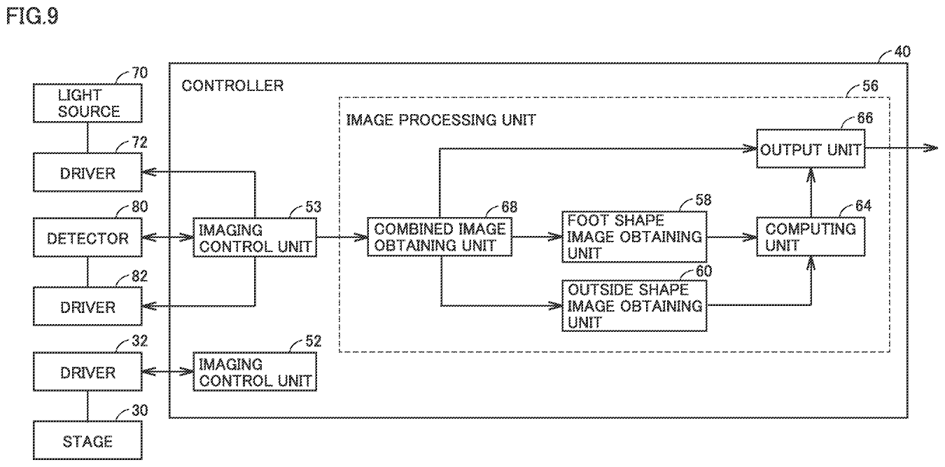

FIG. 9 is a block diagram showing an exemplary functional configuration of controller 40 shown in FIG. 5. As shown in FIG. 9, controller 40 includes imaging control units 52 and 53 and image processing unit 56. Controller 40 according to the second embodiment is different from controller 40 according to the first embodiment in that imaging control unit 53 is included instead of imaging control units 50 and 51 and that image processing unit 56 includes a combined image obtaining unit 68 instead of combination unit 62. Since the second embodiment is otherwise identical in configuration to the first embodiment, description will not be repeated.

Imaging control unit 53 controls drive of light source 70 by driver 72. Specifically, imaging control unit 53 controls generation of terahertz light by terahertz light generator 71 and scanning with terahertz light by the optical system (condenser lens 73 and reflection mirror 74).

Imaging control unit 53 further provides an imaging instruction to detector 80. During imaging by detector 80, imaging control unit 53 activates driver 82 to move detector 80. Transmitted light of terahertz light for scanning of the surface of shoe 2 can thus be detected.

In image processing unit 56, combined image obtaining unit 68 obtains transmitted light detected by detector 80 from imaging control unit 53. Combined image obtaining unit 68 obtains the combined image (image F4 in FIG. 8) based on obtained transmitted light. Combined image obtaining unit 68 generates a three-dimensional combined image based on combined images from a plurality of points of view resulting from imaging by detector 80. A known image processing technique can be adopted for generation of the three-dimensional combined image. Combined image obtaining unit 68 provides output of the combined image to output unit 66, foot shape image obtaining unit 58, and outside shape image obtaining unit 60.

Output unit 66 has the combined image shown on display 34 (see FIG. 5). Output unit 66 further transmits image data of the combined image to an external apparatus through communication I/F 48 (see FIG. 5).

Foot shape image obtaining unit 58 extracts the foot shape image from the combined image generated by combined image obtaining unit 68. Foot shape image obtaining unit 58 extracts the foot shape image based on contrast between shoe 2 and foot 1 that appears in the combined image. A known image processing technique can be applied to extraction of the foot shape image.

Outside shape image obtaining unit 60 extracts the outside shape image from the combined image generated by combined image obtaining unit 68. Outside shape image obtaining unit 60 extracts the outside shape image based on contrast between shoe 2 and foot 1 that appears in the combined image. A known image processing technique can be applied to extraction of the outside shape image.

Computing unit 64 measures the size of the clearance provided between the inner side of shoe 2 and the surface of foot 1 based on the foot shape image obtained by foot shape image obtaining unit 58 and the outside shape image obtained by outside shape image obtaining unit 60. In the example in FIG. 8, size D1 of the clearance provided around the toe portion of foot 1 and size D2 of the clearance provided around the heel portion are measured. A known image analysis technique can be used for measurement. Though not shown, computing unit 64 can measure the size of the clearance around an arch portion and an instep portion of foot 1 based on a combined image from another point of view.

Computing unit 64 provides a measurement value of the size of the clearance to output unit 66. Output unit 66 has the measurement value shown on display 34 (see FIG. 5) and transmits data on the measurement value to an external apparatus through communication I/F 48 (see FIG. 5).

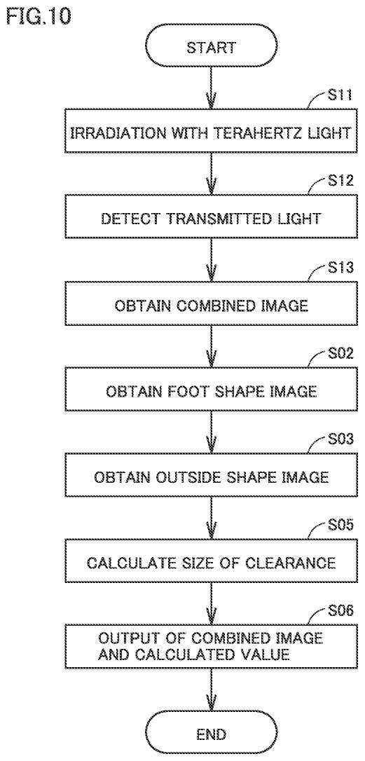

FIG. 10 is a flowchart for illustrating a processing procedure in imaging apparatus 100 according to the second embodiment. The flowchart shown in FIG. 10 is different in including steps S11 to S13 instead of steps S01 and S04 in the flowchart shown in FIG. 4.

As shown in FIG. 10, in step S11, imaging apparatus 100 generates terahertz light like spotlight by means of light source 70 and emits generated terahertz light toward shoe 2. Imaging apparatus 100 scans the surface of shoe 2 with terahertz light by moving light source 70 with driver 72 and/or moving stage 30 with driver 32.

In step S12, imaging apparatus 100 detects terahertz light that has passed through shoe 2 by means of detector 80. Imaging apparatus 100 detects transmitted light from a plurality of points of view by moving detector 80 with driver 82 and/or moving stage 30 with driver 32.

In step S13, controller 40 of imaging apparatus 100 obtains the combined image (image F4 in FIG. 8) based on transmitted light detected by detector 80. Controller 40 obtains the three-dimensional combined image based on transmitted light from a plurality of points of view detected by detector 80.

In step S02, controller 40 obtains the three-dimensional foot shape image by extracting the foot shape image from the combined image obtained in step S13.

In step S03, controller 40 obtains the three-dimensional outside shape image by extracting the outside shape image from the combined image obtained in step S13.

Controller 40 measures the size of the clearance provided between the inner side of shoe 2 and the surface of foot 1 based on the foot shape image and the outside shape image obtained in steps S02 and S03. In step S05, controller 40 measures the size of the clearance provided, for example, around the toe, the heel, the instep, and the arch of foot 1.

In step S06, controller 40 provides output of the combined image and a measurement value of the size of the clearance. Controller 40 has the combined image and the measurement value shown on display 34 and transmits the combined image and data on the measurement value to an external apparatus through communication I/F 48.

As described above, imaging apparatus 100 according to the second embodiment can obtain the combined image of the foot shape image and the outside shape image by irradiating the foot of the subject with his/her shoe on with terahertz light and detecting transmitted light from the shoe. The state (the shape and the position of the foot and the clearance in the inside of the shoe) of the foot with respect to the shoe can visually be detected in the obtained combined image. Thus, whether or not a shoe fits to the foot shape of a user and comfortableness of the shoe can objectively be evaluated without relying on the user's subjective feeling.

### Third Embodiment

In a third embodiment, a first exemplary configuration in which the active imaging technique using reflected light from shoe 2 is employed will be described.

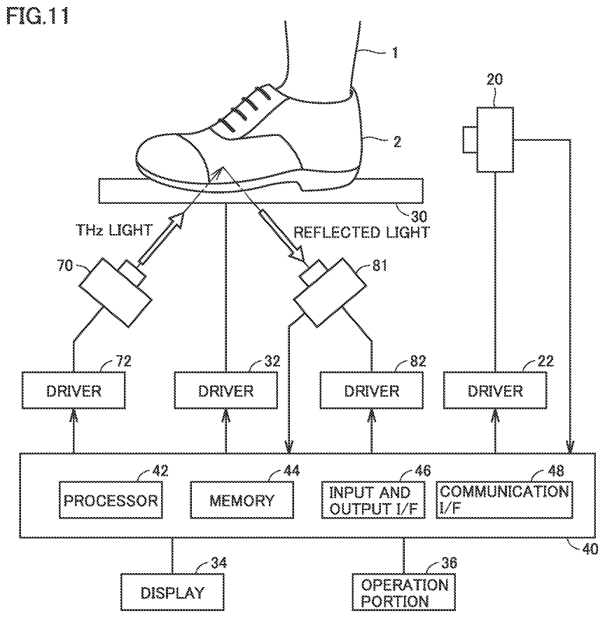

FIG. 11 is a diagram showing a schematic configuration of imaging apparatus 100 according to the third embodiment. As shown in FIG. 11, imaging apparatus 100 according to the third embodiment includes stage 30, light source 70, detectors 20 and 81, drivers 22, 32, 72, and 82, controller 40, display 34, and operation portion 36. Imaging apparatus 100 according to the third embodiment is different from imaging apparatus 100 according to the first embodiment in including light source 70, first detector 81, and drivers 72 and 82 instead of first detector 10 and driver 12. Since the third embodiment is otherwise identical in configuration to the first embodiment, description will not be repeated.

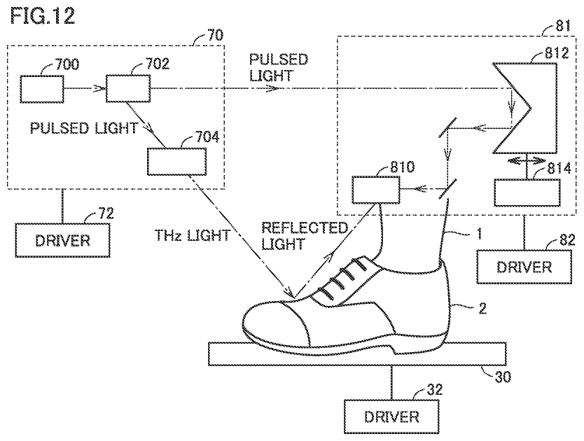

Light source 70 generates terahertz light. Light source 70 is arranged to include at least shoe 2 within a range of irradiation with terahertz light and emits terahertz light toward shoe 2. First detector 81 detects reflected light from shoe 2. FIG. 12 is a diagram showing an exemplary configuration of light source 70 and first detector 81. As shown in FIG. 12, light source 70 includes a laser light source 700, a wave separator 702, and a terahertz light generator 704. Laser light source 700 is implemented, for example, by femtosecond laser and provides output of pulsed light of high power. Wave separator 702 is provided on an optical path of pulsed light and splits pulsed light into two beams of pulsed light. First pulsed light is guided as pump light to terahertz light generator 704. Second pulsed light is guided as probe light to first detector 81.

Terahertz light generator 704 is provided on the optical path of first pulsed light (pump light). Terahertz light generator 704 is implemented, for example, by a photoconductive antenna (PCA) and generates terahertz light based on first pulsed light. Terahertz light is condensed like spotlight by a not-shown optical system and emitted to the surface of shoe 2. This terahertz light is pulsed electromagnetic waves generated based on first pulsed light.

Driver 72 includes a movement mechanism (not shown) that moves the optical system. By driving the movement mechanism, the surface of shoe 2 can be scanned with terahertz light emitted like spotlight. In addition to or instead of drive of light source 70 by driver 72, movement of stage 30 by driver 32 may be used for scanning with terahertz light. Driver 72 and/or driver 32 correspond(s) to one embodiment of “scanning means.”

Terahertz light emitted to the surface of shoe 2 passes through shoe 2 to reach the surface of foot 1. Some of terahertz light is reflected at the surface of foot 1 to become reflected light, and the reflected light passes through shoe 2 again to exit to the outside of shoe 2.

First detector 81 includes a terahertz light detector 810, a delay unit 812, and a driver 814. Terahertz light detector 810 is implemented, for example, by a photoconductive antenna (PCA) and detects reflected light from shoe 2. Specifically, terahertz light detector 810 detects reflected light from shoe 2 in accordance with timing of entry of second pulsed light (probe light).

Delay unit 812 is implemented by an optical delay element that provides delay to second pulsed light. Delay unit 812 is located on the optical path of second pulsed light from wave separator 702 to terahertz light detector 810.

Driver 814 can change timing of second pulsed light reaching terahertz light detector 810 by having delay unit 812 carry out reciprocating movement along a direction of incidence of second pulsed light. Timing of detection of reflected light by terahertz light detector 810 is thus changed. Though reflected light is pulsed light, terahertz light detector 810 can detect intensity of reflected light for each of a plurality of different phases of reflected light by providing delay to second pulsed light. Terahertz light detector 810 can thus detect change over time in intensity of reflected light.

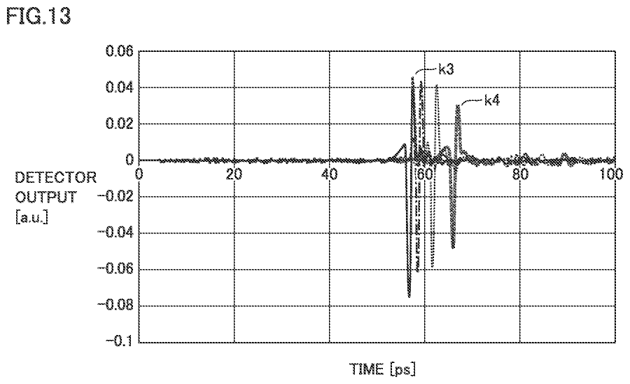

FIG. 13 is a diagram schematically showing a time waveform of intensity of reflected light detected by terahertz light detector 810. FIG. 13 shows a time waveform of reflected light from each part of the surface of foot 1 when shoe 2 is irradiated with terahertz pulsed light.

As shown in FIG. 13, there is a time difference in reflected light from parts of the surface of foot 1. By calculating a depth of each part of the surface of foot 1 by using the TOF method based on this time difference, a foot shape image showing the three-dimensional shape of foot 1 in the inside of shoe 2 can be obtained. In an example in FIG. 13, a depth calculated based on a time difference (approximately 10 ps) between a waveform k3 and a waveform k4 is approximately 1.6 mm.

Referring back to FIG. 12, driver 82 drives first detector 81. Driver 82 includes a movement mechanism (not shown) that moves first detector 81. By driving the movement mechanism to move first detector 81 in synchronization with scanning with terahertz light from light source 70, a foot shape image based on reflected light detected by first detector 81 can be obtained.

In addition to or instead of drive of light source 70 by driver 72 and movement of first detector 81 by driver 82, movement of stage 30 by driver 32 may be used for generation of the foot shape image.

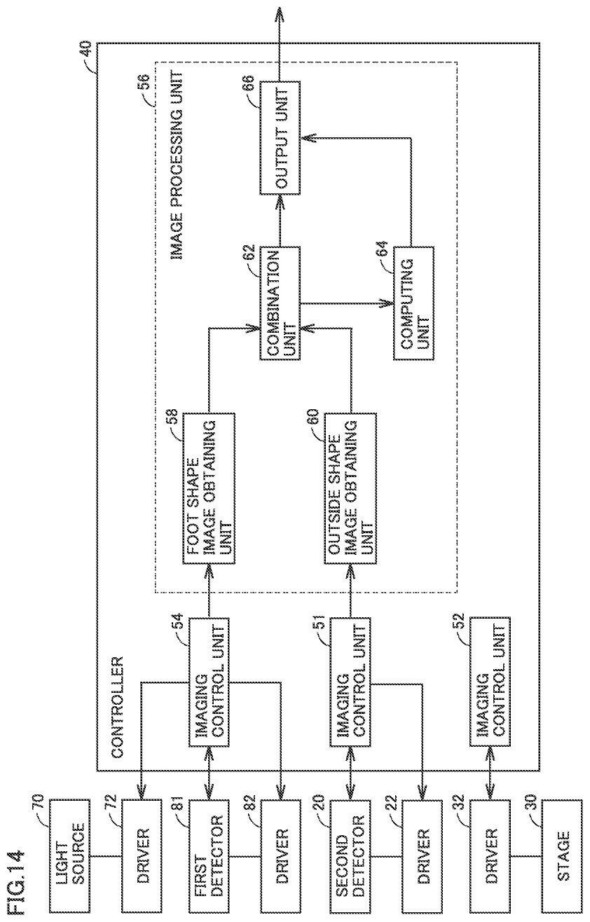

FIG. 14 is a block diagram showing an exemplary functional configuration of controller 40 shown in FIG. 11. As shown in FIG. 14, controller 40 includes imaging control units 51, 52, and 54 and image processing unit 56. Controller 40 according to the third embodiment is different from controller 40 according to the first embodiment in including imaging control unit 54 instead of imaging control unit 50. Since the third embodiment is otherwise identical in configuration to the first embodiment, description will not be repeated.

Imaging control unit 54 controls drive of light source 70 by driver 72. Specifically, imaging control unit 54 controls generation of pulsed terahertz light by light source 70 and scanning with terahertz light.

Imaging control unit 54 further controls operations of first detector 81 and driver 82. Specifically, imaging control unit 54 provides an imaging instruction to first detector 81. During imaging by first detector 81, imaging control unit 54 activates driver 82 to move first detector 81. Reflected light of terahertz light for scanning of the surface of shoe 2 can thus be detected.

Image processing unit 56 includes foot shape image obtaining unit 58, outside shape image obtaining unit 60, combination unit 62, computing unit 64, and output unit 66.

Foot shape image obtaining unit 58 obtains reflected light detected by first detector 81 from imaging control unit 54. Foot shape image obtaining unit 58 generates a three-dimensional foot shape image based on reflected light from a plurality of points of view detected by first detector 81. Specifically, foot shape image obtaining unit 58 generates a three-dimensional foot shape image by determining a depth of each part of the surface of foot 1 based on a time difference in reflected light from each part of the surface of foot 1.

Outside shape image obtaining unit 60 obtains from imaging control unit 51, an outside shape image (two-dimensional image) resulting from imaging by second detector 20. Outside shape image obtaining unit 60 generates a three-dimensional outside shape image based on outside shape images from a plurality of points of view resulting from imaging by second detector 20. A known image processing technique can be adopted for generation of a three-dimensional outside shape image.

Combination unit 62 generates a combined image by combining the foot shape image obtained by foot shape image obtaining unit 58 and the outside shape image obtained by outside shape image obtaining unit 60 with each other. Combination unit 62 provides the generated combined image to output unit 66 and computing unit 64. Output unit 66 has the combined image shown on display 34 (see FIG. 11). Output unit 66 further transmits image data of the combined image to an external apparatus through communication I/F 48 (see FIG. 11).

Computing unit 64 measures the size of the clearance provided between the inner side of shoe 2 and the surface of foot 1 based on the combined image. Computing unit 64 provides a measurement value of the size of the clearance to output unit 66. Output unit 66 has the measurement value shown on display 34 and transmits data on the measurement value to the external apparatus through communication I/F 48.

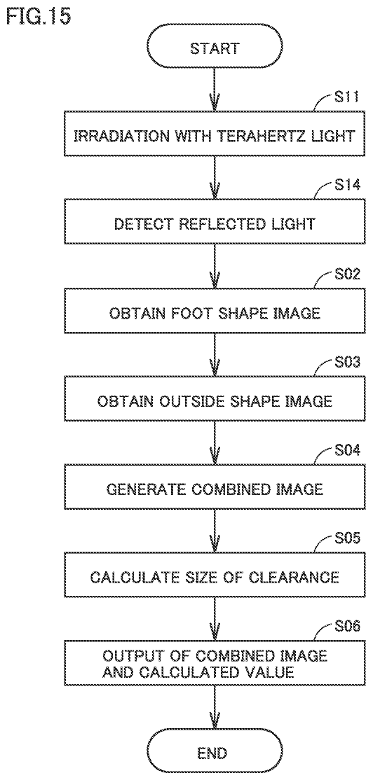

FIG. 15 is a flowchart for illustrating a processing procedure in imaging apparatus 100 according to the third embodiment. The flowchart shown in FIG. 15 is different in including steps S11 and S14 instead of step S01 in the flowchart shown in FIG. 4.

As shown in FIG. 15, in step S11, imaging apparatus 100 generates pulsed terahertz light by means of light source 70 and emits generated terahertz light toward shoe 2. Imaging apparatus 100 scans the surface of shoe 2 with terahertz light by moving light source 70 with driver 72 and/or moving stage 30 with driver 32.

In step S14, imaging apparatus 100 detects terahertz light (reflected light) reflected at the surface of foot 1 in the inside of shoe 2 by means of first detector 81. Imaging apparatus 100 detects reflected light from a plurality of points of view by moving first detector 81 with driver 82 and/or moving stage 30 with driver 32.

In step S02, controller 40 of imaging apparatus 100 obtains the foot shape image based on reflected light detected by first detector 81. Controller 40 generates a three-dimensional foot shape image based on a time difference in reflected light from a plurality of points of view detected by first detector 81.

In step S03, controller 40 obtains the outside shape image resulting from imaging by second detector 20. Controller 40 generates a three-dimensional outside shape image based on outside shape images from a plurality of points of view resulting from imaging by second detector 20.

In step S04, controller 40 generates a combined image by combining the foot shape image obtained in step S02 and the outside shape image obtained in step S03 with each other.

In step S05, controller 40 measures the size of the clearance provided between the inner side of shoe 2 and the surface of foot 1 based on the combined image generated in step S04. In step S05, controller 40 measures the size of the clearance provided, for example, around the toe, the heel, the instep, and the arch of foot 1.

In step S06, controller 40 provides output of the combined image and a measurement value of the size of the clearance. Controller 40 has the combined image and the measurement value shown on display 34 and transmits the combined image and data on the measurement value to an external apparatus through communication I/F 48.

As described above, imaging apparatus 100 according to the third embodiment can visually detect the state (the shape and the position of the foot and the clearance in the inside of the shoe) of the foot with respect to the shoe by irradiating the foot of the subject with his/her shoe on with terahertz light, detecting reflected light from the shoe to obtain the foot shape image and the outside shape image of the shoe, and generating the combined image of the foot shape image and the outside shape image. Thus, whether or not a shoe fits to the foot shape of a user and comfortableness of the shoe can objectively be evaluated without relying on the user's subjective feeling.

### Fourth Embodiment

In a fourth embodiment, a second exemplary configuration in which the active imaging technique using reflected light from shoe 2 will be described.

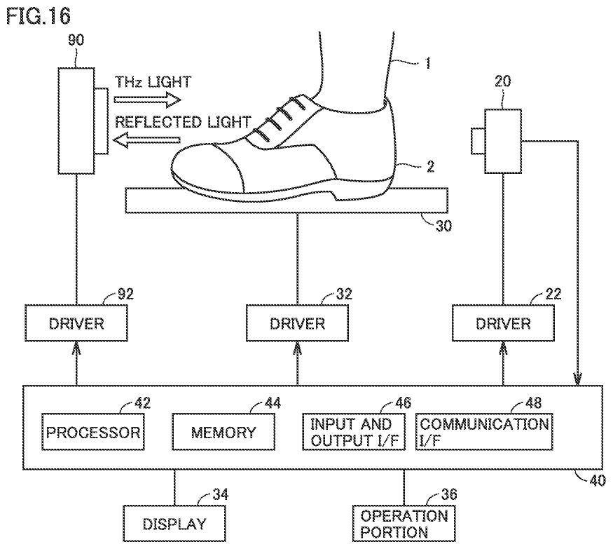

FIG. 16 is a diagram showing a schematic configuration of imaging apparatus 100 according to the fourth embodiment. As shown in FIG. 16, imaging apparatus 100 according to the fourth embodiment includes stage 30, detectors 20 and 90, drivers 22, 32, 72, and 92, controller 40, display 34, and operation portion 36. Imaging apparatus 100 according to the fourth embodiment is different from imaging apparatus 100 according to the first embodiment in including first detector 90 and driver 92 instead of first detector 10 and driver 12. Since the fourth embodiment is otherwise identical in configuration to the first embodiment, description will not be repeated.

First detector 90 is a radar apparatus based on frequency modulated continuous wave (FM-CW). FM-CW refers to a technique for determination of a distance to an object by transmitting frequency-modulated continuous waves toward the object and determining the distance based on a frequency difference between reflected waves that return from the object and transmission waves. Imaging apparatus 100 according to the fourth embodiment is configured to obtain based on FM-CW, a foot shape image that shows the shape of the foot in the inside of shoe 2 based on reflected light detected by first detector 90.

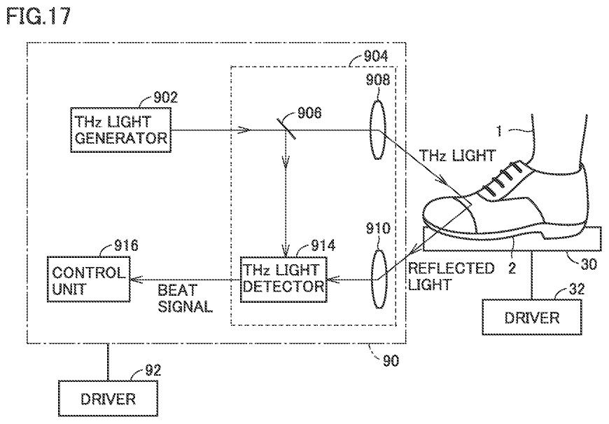

FIG. 17 is a diagram showing an exemplary configuration of first detector 90. As shown in FIG. 17, first detector 90 includes a terahertz light generator 902, a transceiver 904, and a control unit 916.

Terahertz light generator 902 includes, for example, a microwave generator and a frequency multiplier that generates a signal at a target frequency from generated microwaves.

Transceiver 904 includes a wave separator 906, optical systems 908 and 910, and a terahertz light detector 914. Wave separator 906 is provided on an optical path of terahertz light and splits terahertz light into two beams of terahertz light. First terahertz light is guided to optical system 908 including a condenser lens. Second terahertz light is guided as reference light to a delay unit 912.

First terahertz light is emitted to the surface of shoe 2 as being condensed like spotlight by optical system 908. Driver 92 includes a movement mechanism (not shown) that moves optical system 908. By driving the movement mechanism, the surface of shoe 2 can be scanned with terahertz light emitted like spotlight. In addition to or instead of drive of optical system 908 by driver 92, movement of stage 30 by driver 32 may be used for scanning with terahertz light. Driver 92 and/or driver 32 correspond(s) to one embodiment of “scanning means.”

Terahertz light emitted to the surface of shoe 2 passes through shoe 2 to reach the surface of foot 1. Some of terahertz light is reflected at the surface of foot 1 to become reflected light, and the reflected light passes through shoe 2 again to exit to the outside of shoe 2.

Optical system 910 receives reflected light from shoe 2 and provides received reflected light to terahertz light detector 914. Second terahertz light (reference light) is further provided to terahertz light detector 914. Terahertz light detector 914 mixes reflected light and second terahertz light (reference light) with each other, generates a beat signal having a beat frequency fb representing a frequency difference therebetween, and provides the beat signal to control unit 916.

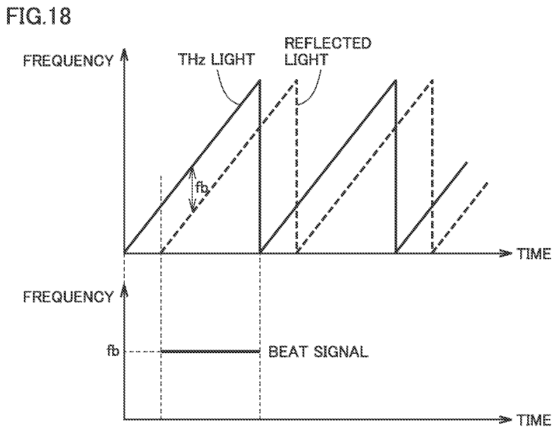

FIG. 18 is a diagram showing measurement principles of first detector 90. FIG. 18 shows a waveform representing change over time in THz light emitted from transceiver 904 toward shoe 2 and reflected light from shoe 2. Control unit 916 measures a distance from first detector 90 to foot 1 based on the beat signal generated by terahertz light detector 914.

Referring back to FIG. 17, driver 92 drives first detector 90. Driver 92 includes a movement mechanism (not shown) that moves first detector 90. First detector 90 can measure a distance to each part of the surface of foot 1 by driving the movement mechanism to move first detector 90 in synchronization with scanning with terahertz light. Controller 40 can obtain the three-dimensional foot shape image based on the distance to each part of the surface of foot 1 calculated by first detector 90. In addition to or instead of movement of first detector 90 by driver 92, movement of stage 30 by driver 32 may be used for generation of a foot shape image.

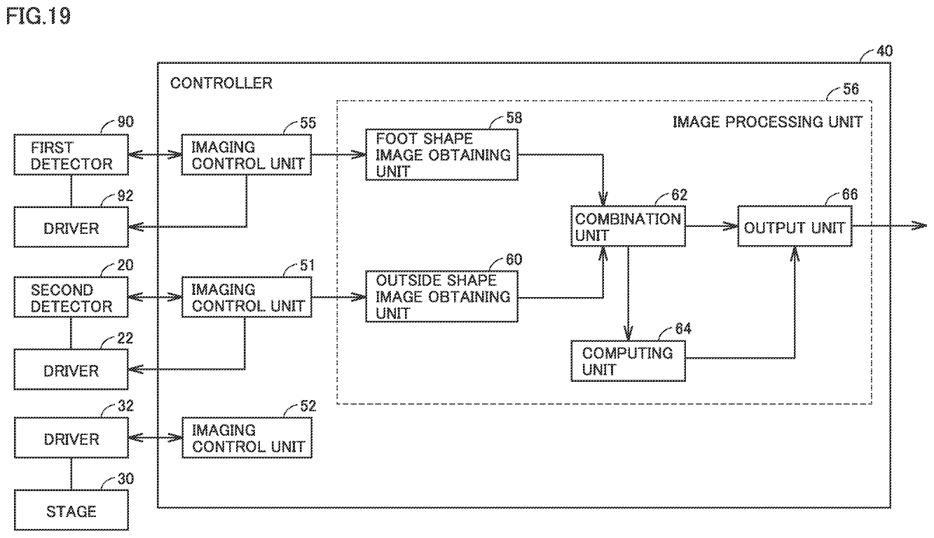

FIG. 19 is a block diagram showing an exemplary functional configuration of controller 40 shown in FIG. 16. As shown in FIG. 19, controller 40 includes imaging control units 51, 52, and 55 and image processing unit 56. Controller 40 according to the fourth embodiment is different from controller 40 according to the first embodiment in including imaging control unit 55 instead of imaging control unit 50. Since the fourth embodiment is otherwise identical in configuration to the first embodiment, description will not be repeated.

Imaging control unit 55 controls operations of first detector 90 and driver 92. Specifically, imaging control unit 55 controls generation of terahertz light and scanning with terahertz light by first detector 90. Imaging control unit 55 further provides an imaging instruction to first detector 90. During imaging by first detector 90, imaging control unit 55 activates driver 92 to move first detector 90. Reflected light of terahertz light for scanning the surface of shoe 2 can thus be detected.

Image processing unit 56 includes foot shape image obtaining unit 58, outside shape image obtaining unit 60, combination unit 62, computing unit 64, and output unit 66.

Foot shape image obtaining unit 58 obtains reflected light detected by first detector 90 from imaging control unit 55. Foot shape image obtaining unit 58 generates a three-dimensional foot shape image based on reflected light from a plurality of points of view detected by first detector 90. Specifically, foot shape image obtaining unit 58 generates a three-dimensional foot shape image by measuring a distance to each part of foot 1 based on beat frequency fb that represents a frequency difference between terahertz light and reflected light.

Outside shape image obtaining unit 60 obtains an outside shape image (two-dimensional image) resulting from imaging by second detector 20 from imaging control unit 51. Outside shape image obtaining unit 60 generates a three-dimensional outside shape image based on outside shape images from a plurality of points of view resulting from imaging by second detector 20. A known image processing technique can be adopted for generation of a three-dimensional outside shape image.

Combination unit 62 generates a combined image by combining the foot shape image obtained by foot shape image obtaining unit 58 and the outside shape image obtained by outside shape image obtaining unit 60 with each other. Combination unit 62 provides the generated combined image to output unit 66 and computing unit 64. Output unit 66 has the combined image shown on display 34 (see FIG. 16). Output unit 66 further transmits image data of the combined image to an external apparatus through communication I/F 48 (see FIG. 16).

Computing unit 64 measures the size of the clearance provided between the inner side of shoe 2 and the surface of foot 1 based on the combined image.

Computing unit 64 provides a measurement value of the size of the clearance to output unit 66. Output unit 66 has a calculated value shown on display 34 and transmits data on the calculated value to the external apparatus through communication I/F 48.

As described above, imaging apparatus 100 according to the fourth embodiment can visually detect the state (the position of the foot and the clearance in the inside of the shoe) of the foot with respect to the shoe by irradiating the foot of the subject with his/her shoe on with terahertz light, detecting reflected light from the shoe to obtain the foot shape image and the outside shape image of the shoe, and generating the combined image of the foot shape image and the outside shape image. Thus, whether or not a shoe fits to the foot shape of a user and comfortableness of the shoe can objectively be evaluated without relying on the user's subjective feeling.

[Modification]

(1) In the embodiment above, the exemplary configuration in which the entire shoe 2 is imaged is described. Imaging apparatus 100, however, may be configured to image a portion of shoe 2 including at least the toe portion and the heel portion. Specifically, in imaging apparatus 100 (see FIG. 1) according to the first embodiment, first detector 10 and second detector 20 obtain the foot shape image showing the shape of the toe and the heel of foot 1 and the outside shape image showing the outside shape of the toe portion and the heel portion of shoe 2 by imaging the toe portion and the heel portion of shoe 2. In imaging apparatus 100 (see FIGS. 5, 11, and 16) according to the second to fourth embodiments, the toe portion and the heel portion of shoe 2 are scanned with terahertz light condensed like spotlight to detect transmitted light or reflected light of terahertz light. Second detector 20 images the toe portion and the heel portion of shoe 2. Since the foot shape image showing the shape of the toe and the heel of foot 1 and the outside shape image showing the outside shape of the toe portion and the heel portion of shoe 2 can thus be obtained, the combined image of the toe and the heel of foot 1 can be obtained.

(2) In the embodiment above, the exemplary configuration in which shoe 2 is imaged while a subject with his/her shoe 2 on stands on stage 30 is described. The configuration, however, may be such that shoe 2 is imaged while the subject is in motion on stage 30. For example, by imaging shoe 2 at the time point of touching of the heel portion of shoe 2 to stage 30 and the time point of toe off of the toe portion of shoe 2 from stage 30 during walking by the subject, the combined image of images at these time points is obtained. The position and the shape of foot 1 and the shape of the clearance in the inside of shoe 2 during walking can thus be detected. Motion of the subject can include knee bending and stretching or stretching of the Achilles tendon other than walking.

(3) In the embodiment above, the exemplary configuration in which a foot shape image of a subject is obtained as the body contour image and an image showing the outside shape of the shoe is obtained as the outside shape image is described. Imaging apparatus 100 according to each embodiment, however, can also be applied to a configuration in which a target portion of a subject with apparel other than the shoe being put thereon is imaged.

For example, by imaging a trunk, an arm, and a lower limb of a subject with his/her clothing on, a combined image resulting from combination of the body contour image showing the shape of the trunk, the arm, and the lower limb (which is referred to as the trunk etc. below) in the inside of the clothing and the outside shape image showing the outside shape of the clothing with each other can be obtained. A position of the trunk etc. with respect to the clothing can visually be detected based on the obtained combined image. A size of the clearance provided between the clothing and the trunk etc. can be measured. Consequently, comfortableness of the clothing can objectively be evaluated.

Alternatively, by imaging a head portion of a subject with his/her headwear on, a combined image resulting from combination of the body contour image showing the shape of the head portion in the inside of the headwear and the outside shape image showing the outside shape of the headwear with each other can be obtained. Based on the obtained combined image, the position of the head portion with respect to the headwear can visually be detected and the size of the clearance provided between the headwear and the head portion can be measured.

[Aspects]

A plurality of illustrative embodiments described above are understood by a person skilled in the art as specific examples of aspects below.

(Clause 1)

An imaging apparatus according to one aspect includes a body contour imager that obtains a body contour image that shows a body contour of a target portion of a subject, by detecting terahertz light radiated from the target portion of the subject with the subject's apparel on, an outside shape imager that obtains an outside shape image that shows an outside shape of the apparel in the target portion, combination means that generates a combined image by combining the body contour image and the outside shape image with each other, and output means that provides output of the combined image generated by the combination means.

According to the imaging apparatus described in Clause 1, a state of the target portion with respect to the apparel (the shape and the position of the target portion in the inside of the apparel and the clearance provided between the apparel and the target portion) can visually be detected by detecting terahertz light radiated from the target portion of the subject with the subject's apparel on to obtain the body contour image and the outside shape image of the apparel and generating the combined image of the body contour image and the outside shape image. Thus, whether or not the apparel fits to the body contour of a user and fitting of the apparel can objectively be evaluated without relying on subjective feeling of the user.

(Clause 2)

An imaging apparatus according to another aspect includes a light source that generates terahertz light, a body contour imager that obtains a body contour image that shows a body contour of a target portion of a subject, by irradiating the target portion of the subject with the subject's apparel on with the terahertz light from the light source, an outside shape imager that obtains an outside shape image that shows an outside shape of the apparel in the target portion, and output means that provides output of a combined image obtained by combining the body contour image and the outside shape image with each other.

According to the imaging apparatus described in Clause 2, the combined image of the body contour image and the outside shape image can be obtained by irradiating the target portion of the subject with the subject's apparel on with terahertz light to obtain the body contour image and the outside shape image of the apparel. With the obtained combined image, a state of the target portion with respect to the apparel can visually be detected. Thus, whether or not apparel fits to the body contour of a user and fitting of the apparel can objectively be evaluated without relying on subjective feeling of the user.

(Clause 3)

The imaging apparatus described in Clause 2 further includes a combined imager that obtains the combined image by detecting the terahertz light that has passed through the target portion. The body contour imager obtains the body contour image from the obtained combined image, based on the terahertz light that has passed through the target portion at first transmittance. The outside shape imager obtains the outside shape image from the obtained combined image, based on the terahertz light that has passed through the target portion at second transmittance higher than the first transmittance.

According to the imaging apparatus described in Clause 3, the combined image of the body contour image and the outside shape image can be obtained by irradiating the target portion of the subject with the subject's apparel on with terahertz light and detecting transmitted light from the target portion.

(Clause 4)

In the imaging apparatus described in Clause 2, the body contour imager obtains the body contour image by detecting the terahertz light reflected at the target portion. The outside shape imager obtains the outside shape image by detecting electromagnetic waves different from the terahertz light.

According to the imaging apparatus described in Clause 4, the body contour image can be obtained by irradiating the target portion of the subject with the subject's apparel on with terahertz light and detecting reflected light from the target portion. The combined image can be obtained by combining the obtained body contour image and the outside shape image obtained by detection of electromagnetic waves different from terahertz light with each other.

(Clause 5)

In the imaging apparatus described in Clause 4, the light source is configured to irradiate the target portion with pulses of the terahertz light. The body contour imager obtains the body contour image in three dimensions based on a time of flight of the pulses reflected back from the target portion.

According to the imaging apparatus described in Clause 5, the body contour image can be obtained by irradiating the target portion of the subject with the subject's apparel on with pulses of terahertz light and detecting reflected light from the target portion.

(Clause 6)

In the imaging apparatus described in Clause 4, the light source is configured to generate continuous waves of the terahertz light. The body contour imager obtains the body contour image in three dimensions based on a frequency difference between the continuous waves emitted from the light source and the continuous waves reflected back from the target portion.

According to the imaging apparatus described in Clause 6, the body contour image can be obtained by irradiating the target portion of the subject with the subject's apparel on with continuous waves of terahertz light and detecting reflected light from the target portion.

(Clause 7)

In the imaging apparatus described in Clauses 1 to 6, the output means has the combined image shown on a display.

According to the imaging apparatus described in Clause 7, the state (the shape and the position of the target portion and the clearance provided between the apparel and the target portion) of the target portion in the inside of the apparel can visually be detected based on the combined image shown on the display.

(Clause 8)

The imaging apparatus described in Clauses 1 to 7 further includes computing means that obtains from the combined image, information on a clearance provided between the apparel and the target portion.

According to the imaging apparatus described in Clause 8, the position and the size of the clearance provided between the apparel and the target portion can be measured. Therefore, whether or not the apparel fits to the body contour of a user and fitting of the apparel can objectively be evaluated without relying on subjective feeling of the user.

(Clause 9)

In the imaging apparatus described in Clauses 2 to 6, the light source is configured to irradiate a surface of the apparel with the terahertz light condensed like spotlight. The imaging apparatus further includes scanning means that scans the surface of the apparel with the terahertz light by moving at least one of the light source and the subject.

According to the imaging apparatus described in Clause 9, the body contour image showing the three-dimensional shape of the target portion can be obtained by detecting transmitted light or reflected light of terahertz light for scanning of the surface of the apparel.

(Clause 10)

In the imaging apparatus described in Clause 9, the apparel is a shoe. The target portion includes a toe and a heel of a foot of the subject. The scanning means scans a surface of a toe portion and a heel portion of the shoe with the terahertz light.

According to the imaging apparatus described in Clause 10, the shape and the position of the toe and the heel of the foot and the clearance provided between the shoe and the toe or the heel in the inside of the shoe can visually be detected. Thus, whether or not the shoe fits to the foot shape of a user and comfortableness of the shoe can objectively be evaluated without relying on subjective feeling of the user.

(Clause 11)

An imaging method according to one aspect includes obtaining a body contour image that shows a body contour of a target portion of a subject by detecting terahertz light radiated from the target portion of the subject with the subject's apparel on, obtaining an outside shape image that shows an outside shape of the apparel in the target portion, generating a combined image by combining the body contour image and the outside shape image with each other, and providing output of the generated combined image.

According to the imaging method described in Clause 11, the state of the target portion with respect to the apparel can visually be detected by detecting terahertz light radiated from the target portion of the subject with the subject's apparel on to obtain the body contour image and the outside shape image of the apparel and generating the combined image of the body contour image and the outside shape image. Thus, whether or not the apparel fits to the body contour of a user and fitting of the apparel can objectively be evaluated without relying on subjective feeling of the user.

(Clause 12)

An imaging method according to another aspect includes obtaining a body contour image that shows a body contour of a target portion of a subject by irradiating the target portion of the subject with the subject's apparel on with terahertz light generated by a light source, obtaining an outside shape image that shows an outside shape of the apparel in the target portion, and providing output of a combined image obtained by combining the body contour image and the outside shape image with each other.

According to the imaging method described in Clause 12, the combined image resulting from combination of the body contour image and the outside shape image with each other can be obtained by irradiating the target portion of the subject with the subject's apparel on with terahertz light to obtain the body contour image and the outside shape image of the apparel. With the obtained combined image, the state of the target portion with respect to the apparel can visually be detected. Thus, whether or not the apparel fits to the body contour of a user and fitting of the apparel can objectively be evaluated without relying on subjective feeling of the user.

(Clause 13)

In the imaging method described in Clauses 11 and 12, the apparel is a shoe. The target portion is a foot of the subject. The obtaining a body contour image includes obtaining a foot shape image that shows a shape of the foot of the subject who is in motion. The obtaining an outside shape image includes obtaining the outside shape image that shows an outside shape of the shoe of the subject who is in motion.

According to the imaging method described in Clause 13, the combined image of the foot shape image of the subject in motion and the outside shape image is obtained. The state of the foot with respect to the shoe while the subject is in motion can thus visually be detected.

In the first to fourth embodiments and modifications described above, combination as appropriate of features described in each embodiment, including combination not mentioned herein, is originally intended so long as no inconvenience or inconsistency is caused.

Though embodiments of the present invention have been described, it should be understood that the embodiments disclosed herein are illustrative and non-restrictive in every respect. The scope of the present invention is defined by the terms of the claims and is intended to include any modifications within the scope and meaning equivalent to the terms of the claims.

What is claimed is:

1. An imaging apparatus comprising:
a body contour imager that obtains a body contour image that shows a body contour of a target portion of a subject, by detecting terahertz light radiated from the target portion of the subject with the subject's apparel on;
an outside shape imager that obtains an outside shape image that shows an outside shape of the apparel in the target portion;
combination means that generates a combined image by combining the body contour image and the outside shape image with each other; and
output means that provides output of the combined image generated by the combination means.

2. An imaging apparatus comprising:
a light source that generates terahertz light;
a body contour imager that obtains a body contour image that shows a body contour of a target portion of a subject, by irradiating the target portion of the subject with the subject's apparel on with the terahertz light from the light source;
an outside shape imager that obtains an outside shape image that shows an outside shape of the apparel in the target portion; and
output means that provides output of a combined image obtained by combining the body contour image and the outside shape image with each other.

3. The imaging apparatus according to claim 2, further comprising a combined imager that obtains the combined image by detecting the terahertz light that has passed through the target portion, wherein
the body contour imager obtains the body contour image from the obtained combined image, based on the terahertz light that has passed through the target portion at first transmittance, and
the outside shape imager obtains the outside shape image from the obtained combined image, based on the terahertz light that has passed through the target portion at second transmittance higher than the first transmittance.

4. The imaging apparatus according to claim 2, wherein
the body contour imager obtains the body contour image by detecting the terahertz light reflected at the target portion, and
the outside shape imager obtains the outside shape image by detecting electromagnetic waves different from the terahertz light.

5. The imaging apparatus according to claim 4, wherein
the light source is configured to irradiate the target portion with pulses of the terahertz light, and
the body contour imager obtains the body contour image in three dimensions based on a time of flight of the pulses that return from the target portion.

6. The imaging apparatus according to claim 4, wherein
the light source is configured to generate continuous waves of the terahertz light, and
the body contour imager obtains the body contour image in three dimensions based on a frequency difference between the continuous waves emitted from the light source and the continuous waves that return from the target portion.

7. The imaging apparatus according to claim 1, wherein
the output means has the combined image shown on a display.

8. The imaging apparatus according to claim 2, wherein
the output means has the combined image shown on a display.

9. The imaging apparatus according to claim 1, further comprising computing means that obtains from the combined image, information on a clearance provided between the apparel and the target portion.

10. The imaging apparatus according to claim 2, further comprising computing means that obtains from the combined image, information on a clearance provided between the apparel and the target portion.

11. The imaging apparatus according to claim 2, wherein
the light source is configured to irradiate a surface of the apparel with the terahertz light condensed like spotlight, and
the imaging apparatus further comprises scanning means that scans the surface of the apparel with the terahertz light by moving at least one of the light source and the subject.

12. The imaging apparatus according to claim 11, wherein
the apparel is a shoe,
the target portion includes a toe and a heel of a foot of the subject, and
the scanning means scans a surface of a toe portion and a heel portion of the shoe with the terahertz light.

13. An imaging method comprising:
obtaining a body contour image that shows a body contour of a target portion of a subject by detecting terahertz light radiated from the target portion of the subject with the subject's apparel on;
obtaining an outside shape image that shows an outside shape of the apparel in the target portion;
generating a combined image by combining the body contour image and the outside shape image with each other; and
providing output of the generated combined image.

14. The imaging method according to claim 13, wherein
the apparel is a shoe,
the target portion is a foot of the subject,
the obtaining a body contour image includes obtaining a foot shape image that shows a shape of the foot of the subject who is in motion; and
the obtaining an outside shape image includes obtaining the outside shape image that shows an outside shape of the shoe of the subject who is in motion.

15. An imaging method comprising:
obtaining a body contour image that shows a body contour of a target portion of a subject by irradiating the target portion of the subject with the subject's apparel on with terahertz light generated by a light source;
obtaining an outside shape image that shows an outside shape of the apparel in the target portion; and
providing output of a combined image obtained by combining the body contour image and the outside shape image with each other.

16. The imaging method according to claim 15, wherein
the apparel is a shoe,
the target portion is a foot of the subject,
the obtaining a body contour image includes obtaining a foot shape image that shows a shape of the foot of the subject who is in motion; and
the obtaining an outside shape image includes obtaining the outside shape image that shows an outside shape of the shoe of the subject who is in motion.
